(19) United States
(12) Patent Application Publication
(10) Pub. No.: US 2007/0284209 A1
(43) Pub. Date: Dec. 13, 2007

(54) One-way bearing

(75) Inventor: I-Heng Chen, Taoyuan City (TW)

Correspondence Address: TROXELL LAW OFFICE PLLC;SUITE 1404, 5205 LEESBURG PIKE, FALLS CHURCH, VA, 22041, US

(73) Assignees: Lu Wei Precision Industry Co., Ltd.; I-Heng CHENG

(21) Appl. No.: 11/448,030

(22) Filed: Jun. 7, 2006

(51) Int. Cl. F16D 41/07

(52) U.S. Cl. 192/45.1

(57) ABSTRACT

A one-way bearing, provided with a passive element on its outer periphery and connected with an axle rod with its inner periphery, comprises a collar, a lid and a plurality of braking blocks. The collar has thereon a plurality of spaced notches, and the braking blocks are respectively rotatably received in the notches of the collar. The braking blocks are provided each with a braking portion; when the axle rod rotates in one direction, the axle rod is linked up with the passive element; when the axle rod rotates in a contrary direction, the braking portions have no function, so that the power of the axle rod and the passive element will be interrupted.

### BACKGROUND OF THE INVENTION

1. Field of the Invention

The present invention relates to a bearing, and more particularly to a one-way bearing having a plurality of braking blocks respectively rotatably received in a space formed from a collar and a lid, and an axle rod can be rotated in one-way by action of the braking portions on the braking blocks.

2. Description of the Prior Art

A bearing can be used for a variety of purposes. In particular, it can be used on various machines for transmission. And one-way bearings for specific kind usages having the function of anti-reverse rotation are largely used on power machines such as bicycles.

A one-way bearing can also be called as a one-way clutch. When a power source (such as an axle rod) drives a passive element, the bearing can transmit in a direction, and if the power source changes its direction (such as changing from the clockwise direction to the counterclockwise direction), the function of transmission of the passive element will be stopped. Because the clutch just can transmit the torque in one direction, and the other direction is an idle operation, so that a reversing action of the working piece can be prevented when there is no power,

Referring to FIG. 10, it is a sectional view of a conventional one-way bearing “a”, the outer periphery of the one-way bearing “a” matches with an axle hole b1 of a passive element “b”, the inner periphery of the one-way bearing “a” is connected with an axle rod “c” for transmitting power. The one-way bearing “a” mainly includes an upper positioning ring “a1”, a fixing elastic sheet “a2”, a lower positioning ring “a3” and a plurality of braking blocks “a4”. The upper positioning ring “a1”, the fixing elastic sheet “a2” and the lower positioning ring “a3” are provided respectively with a plurality of holes “d” for respectively receiving the braking blocks “a4”. The two lateral sides of each braking block “a4” are recessed toward each other, in order that when the fixing elastic sheet “a2” are positioned, the braking block “a4” can be rotated to and fro. Each of the braking blocks “a4” has a long diagonal portion and a short diagonal portion crossing with each other, so that when the axle rod “c” connected with the inner periphery of the one-way bearing “a” is rotated counterclockwise, the axle rod “c” is engaged by the long diagonal portions to link up the axle rod “c” with the passive element “b”. When the axle rod “c” is rotated clockwise, the long diagonal portions have no function, so that the power of the axle rod “c” and the passive element “b” will be interrupted.

With the above stated structure, an objective for preventing reverse rotation can be achieved effectively. However, the said structure includes more components, so that the costs of the materials and processing are relatively higher. Further, because the central portion of the braking block is narrower and the two ends of the braking block are wider, and the central portion of the through holes formed after assembling of the upper positioning ring, the fixing elastic sheet is wider, and the two ends are narrower, thereby the braking blocks are not easy for placing in the through holes during the process of mounting.

Moreover, in practical operation, when positioning the braking blocks in the through holes, some braking blocks are unable to contact with the axle rod. This results uneven force distribution for rendering the one-way bearing unable to run stably and is subjected to damaging.

In order to improve the above-mentioned disadvantages, i.e. for the objectives that not only the one-way bearing can run stably to prolong its life for use, but also the components can be reduced, and the cost of processing and assembling can be reduced too. The inventor provides the present invention based on his professional experience of years and hard studying.

### SUMMARY OF THE INVENTION

The primary objective of the present invention is to provide a one-way bearing, the bearing has a structure in notches of a collar thereof able to achieve an objective of rotating braking blocks in one-way for preventing reverse rotation.

The secondary objective of the present invention is to provide a one-way bearing, by assembling of a collar, a lid and a plurality of braking blocks therein, the bearing can thus have a function of anti-reverse rotation. In addition, the bearing uses fewer components as compared with those of the conventional technique and can thus reduce the cost of production.

Another objective of the present invention is to provide a one-wayb earing, by having a plurality of spaced notches on a collar thereof, a plurality of braking blocks thereof can be placed in easily. This can reduce the manpower during assembling.

Therefore, in order to achieve the above objectives, an outer periphery of the one-way bearing of the present invention matches with an axle hole of a passive element, an inner periphery of the one-way bearing is connected with an axle rod. The one-way bearing comprises a collar, a lid and a plurality of braking blocks. The collar is provided with a plurality of spaced notches, on one side of the collar there is a plurality of first fixing portions, the lid has on its one side a plurality of second fixing portions for respectively connecting with the first fixing portions of the collar. The braking blocks are respectively rotatably received in the notches of the collar; the braking blocks are provided each with a braking portion to restrain the axle rod to rotate in one way.

In practical application, the first fixing portions of the collar are riveted together with the second fixing portions of the lid. The braking blocks each is in the shape of a parallelogram in which there are a long diagonal portion and a short diagonal portion crossing with each other, one end of the long diagonal portion forms a braking portion.

For the purpose that the braking blocks can rotate in the notches on the collar, the one-way bearing can be provided with abutting portions and cooperating receiving portions, the abutting portions are formed each on one side of a corresponding one of the notches on the collar, the receiving portions are formed each on one side of a corresponding one of the braking blocks.

Further, in order to render the braking blocks to rotate in the notches on the collar, the one-way bearing can be provided with first positioning portions and second positioning portions. The first positioning portions are provided respectively on upper and lower ends of the braking blocks; each second positioning portion includes a first position limiting portion and a second position limiting portion, the first position limiting portion is provided on a bottom side of a corresponding one of the notches on the collar, the second position limiting portion is provided on a bottom side of the lid.

And more, in order to render the braking blocks to operate assuredly, the collar is provided on its one side with a plurality of recessed portions to respectively receive a plurality of springs. And the bottom side of the lid is provided with a plurality of protruding portions to be respectively received in the recessed portions and to respectively make positioning of the springs that are abutted each against one side of a braking block.

The present invention will be apparent after reading the detailed description of the preferred embodiment thereof in reference to the accompanying drawings.

### BRIEF DESCRIPTION OF THE DRAWINGS

FIG. 1 is an anatomic perspective view showing the elements in the first embodiment of the present invention;

FIG. 2 is a front view showing a braking block of the first embodiment of the present invention;

FIG. 3 is a sectional view in assembling the first embodiment of the present invention;

FIG. 4 is a front view in assembling the first embodiment of the present invention;

FIG. 5 is a schematic view showing another status in operation of a receiving portion of the braking block and an abutting portion of a collar of the first embodiment of the present invention;

FIG. 6 is a schematic view showing a status in operation of the first embodiment of the present invention;

FIG. 7 is a schematic view showing the other status in operation of the first embodiment of the present invention;

FIG. 8 is a front view in assembling partial elements of the second embodiment of the present invention;

FIG. 9 is a sectional view in assembling the second embodiment of the present invention; and

FIG. 10 is a sectional view in assembling a conventional one-way bearing.

### DETAILED DESCRIPTION OF THE PREFERRED EMBODIMENTS

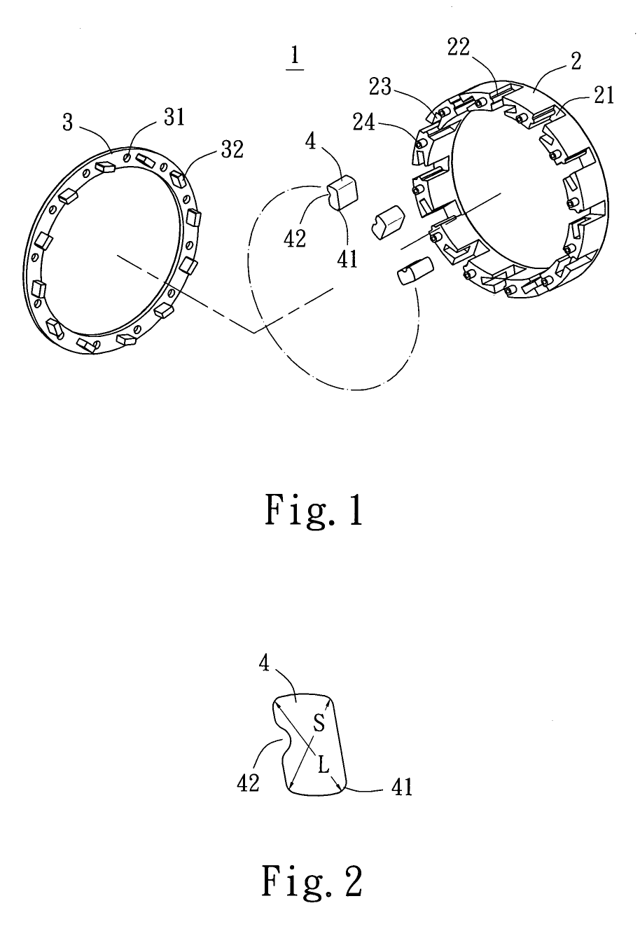

Referring firstly to FIG. 1 shows the first embodiment of a one-way bearing 1 of the present invention, the one-way bearing comprises a collar 2, a lid 3 and a plurality of braking blocks 4.

The collar 2 is in the shape of a round pipe, and includes an upper side and a lower side contrary in facing direction to each other. The upper side of the collar 2 is provided with a plurality of elongate notches 21 arranged in a round array and recessed downwards, a protruding rib extends out of one side of each of the notches 21 of the collar 2, the protruding rib is used as an abutting portion 22, and a recessed portion 23 is formed on the other side of the notch 21. In addition, the collar 2 is provided with a plurality of columns protruding from the upper side of the collar 2, the columns are used as first fixing portions 24.

The lid 3 is in the shape of a short round pipe, and includes an upper side and a lower side contrary in facing direction to each other, one surface of the lid 3 is provided with a plurality of holes in corresponding respectively with the first fixing portions 24 of the collar 2, the holes function as second fixing portions 31. The lower side of the lid 3 is provided with a plurality of rectangular protruding blocks that correspond to the recessed portion 23 of the collar 2, the protruding blocks function as protruding portions 32.

The braking blocks 4 are respectively rotatably received in the notches 21 of the collar 2. The braking blocks 4 each is in the shape of a parallelogram in which there are a long diagonal portion “L” and a short diagonal portion “S” crossing with each other (as shown in FIG. 2). The one end of the long diagonal portion “L” forms a braking portion 41. A recess is formed on one lateral side of each of the braking blocks 4, the recess functions as a receiving portion 42.

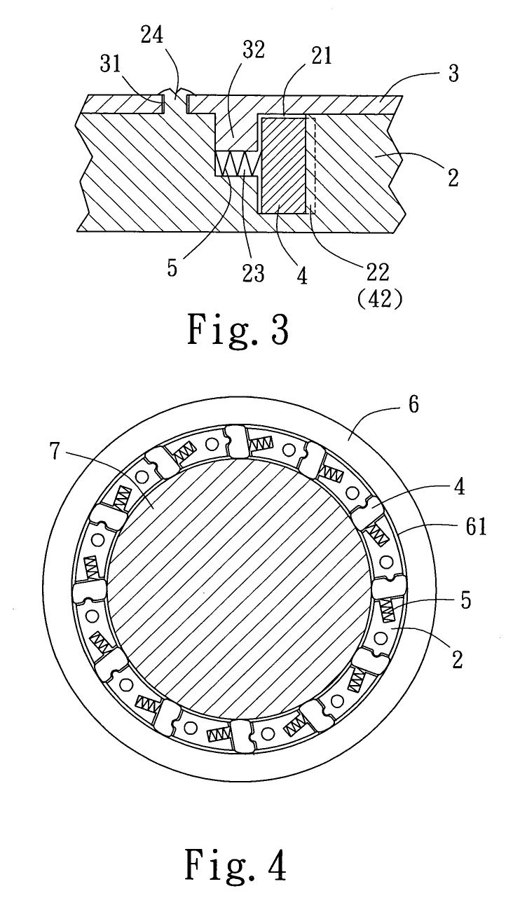

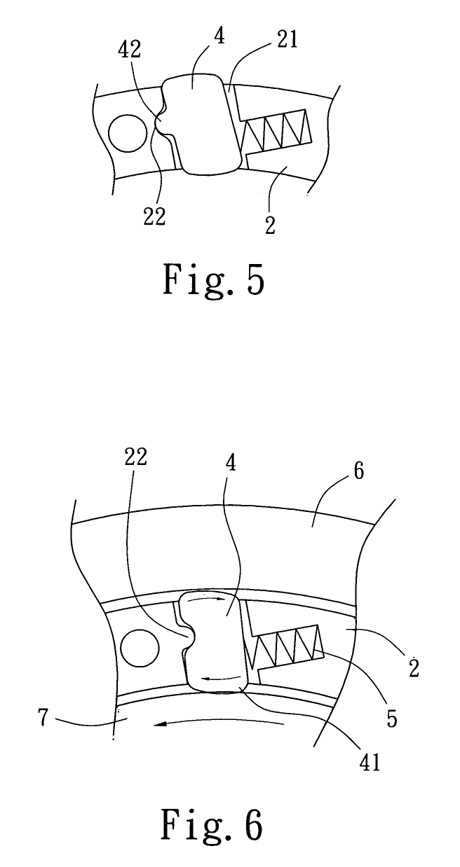

Referring to FIGS. 3 and 4, in assembling the present invention, a plurality of springs 5 are placed respectively in the recessed portions 23 of the collar 2, the braking blocks 4 are placed from above the collar 2 down respectively in the notches 21, thereby the receiving portion 42 of every braking block 4 cooperates with an abutting portion 22 of a notch 21 of the collar 2, in order to position the braking block 4. The receiving portion 42 on one lateral side of the braking block 4 can also be a protruding rib, the abutting portion 22 of a notch 21 of the collar 2 is an elongate recess (as shown in FIG. 5), the protruding rib and the elongate recess can similarly cooperate to position the braking block 4.

When the lid 3 covers the collar 2 from above, the first fixing portions 24 of the collar 2 are extended respectively through the second fixing portions 31 of the lid 3, the lid 3 and the collar 2 are then connected with each other by the mode of riveting. The mode of connecting of the lid 3 with the collar 2 can also be locking, welding or embedding, no specific limitation is given here. When the protruding portions 32 on the lower side of the lid 3 are placed respectively in the recessed portions 23 of the collar 2, the springs 5 can be respectively positioned, and one end of each spring 5 can be abutted against the other lateral side of a braking block 4.

As shown in FIG. 4, in practical application, the outer periphery of the present invention matches with an axle hole 61 provided on an outer sleeve, the inner periphery of the present invention is connected axially with an axle rod 7. The outer sleeve functions as a passive element 6, the passive element 6 can also be a gear or some other mechanical member to bear a force for transmission.

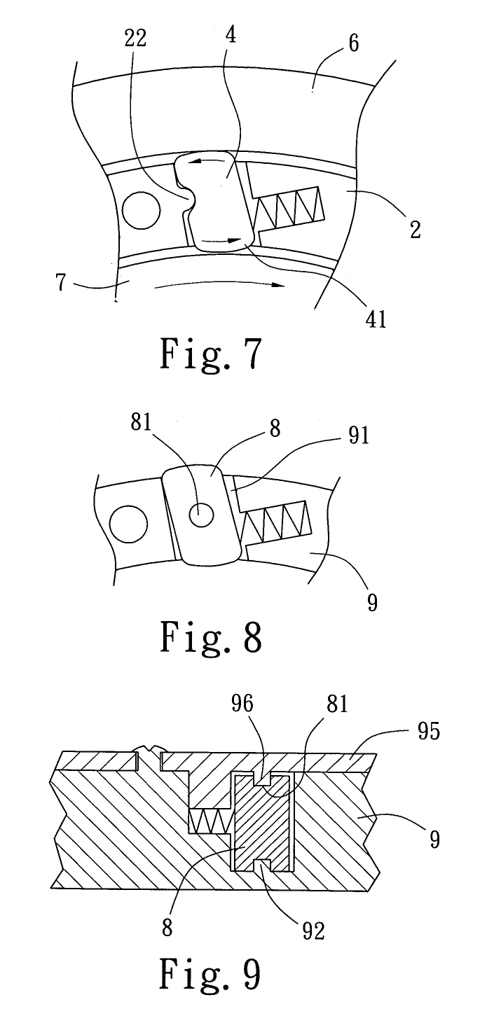

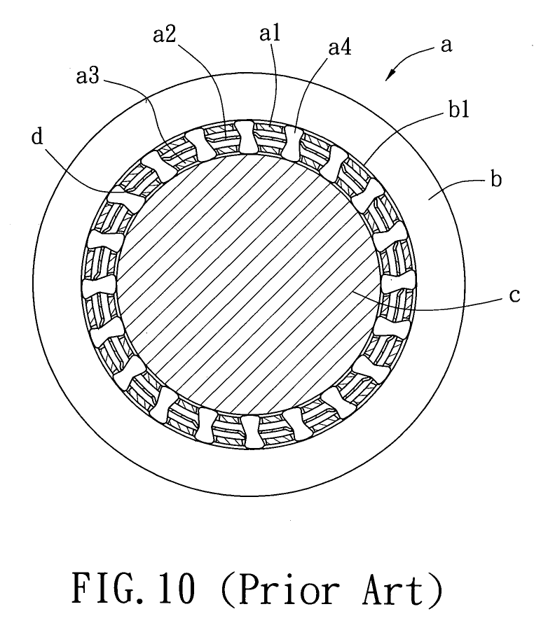

Referring to FIG. 6 which is a schematic view showing a status in operation of the present invention, wherein when the axle rod 7 is rotated counterclockwise, the braking block 4 is rotated clockwise taking the abutting portion 22 of the collar 2 as a fulcrum, the braking portion 41 of the braking block 4 will engage the axle rod 7 to make linkage of the axle rod 7 with the passive element 6, the spring 5 abuts with its one end against the other lateral side of a braking block 4 to make firmer of the above engagement. As shown in FIG. 7, when the axle rod 7 is rotated clockwise, the braking block 4 is rotated counterclockwise, the braking portion 41 of the braking block 4 will not engage the axle rod 7, thereby the power is interrupted between the axle rod 7 and the passive element 6.

Further referring to FIGS. 8 and 9 showing the second embodiment of the present invention, wherein the upper end and the lower end of each of a plurality of braking blocks 8 are provided each with an axle hole, the upper and the lower axle holes are coaxial and function as first positioning portions 81. The bottom side of one of a plurality of notches 91 on a collar 9 is provided with an upper protruding stub, the upper protruding stub functions as a first position limiting portion 92; and a bottom side of a lid 95 is provided with a plurality of lower protruding stubs functioning as second position limiting portions 96. When in assembling, the first position limiting portions 92 on the collar 9 and the second position limiting portions 96 on the lid 95 are axially connected respectively with the first positioning portions 81 on the upper ends and the lower ends of the braking blocks 8, so that the braking blocks 8 rotate in predetermined directions, and the braking blocks 8 can make continuation or interrupt the power between the axle rod 7 and the passive element 6.

Therefore, the present invention has the following advantages:
1. The present invention is structurally simple. It can effectively reduce the cost of materials as well as production.
2. The braking blocks provided by the present invention can be placed in notches on a collar easily. This can reduce the manpower during assembling and increase the speed of assembling.
3. The braking blocks provided by the present invention can be accurately positioned in the notches of the collar, so that the plural braking blocks can simultaneously act with the axle rod and can be more stably in operation to further prolong the life of use of the one-way bearing.

In conclusion, according to the description disclosed above, the present invention can achieve the expected objectives and provide a one-way bearing that can run stably to prolong its life of use, of which the components and the materials used and the cost of processing and assembling can be reduced.

1. A one-way bearing of which an outer periphery matches with an axle hole of a passive element and an inner periphery is connected with an axle rod, said one-way bearing comprises:
a collar having thereon a plurality of spaced notches, on an upper side of said collar there is a plurality of first fixing portions;
a lid having on its one side a plurality of second fixing portions for respectively connecting with said first fixing portions of said collar; and
a plurality of braking blocks being respectively rotatably received in said notches of said collar, said braking blocks are provided each with a braking portion to restrain said axle rod to rotate in one way.

2. The one-way bearing as claimed in claim 1, wherein, said the first fixing portion of said collar is a cylindrical column, said the second fixing portion is a through hole.

3. The one-way bearing as claimed in claim 2, wherein, said first fixing portions of said collar are connected respectively with said second fixing portions of said lid by the mode of riveting.

4. The one-way bearing as claimed in claim 1, wherein, said braking blocks each is in a shape of a parallelogram in which there are a long diagonal portion and a short diagonal portion crossing with each other, one end of said long diagonal portion forms a braking portion.

5. The one-way bearing as claimed in claim 1, wherein, said one-way bearing is provided with abutting portions and cooperating receiving portions, said abutting portions are formed each on one side of a corresponding one of said notches on said collar, said receiving portions are formed each on one side of a corresponding one of said braking blocks.

6. The one-way bearing as claimed in claim 5, wherein, said receiving portions are recesses, and said abutting portions are protruding ribs.

7. The one-way bearing as claimed in claim 1, wherein, said one-way bearing is provided with mutually cooperating first positioning portions and second positioning portions; each of said first positioning portions is provided on an upper and a lower end of a corresponding one of said braking blocks; each of said second positioning portions includes a first position limiting portion and a second position limiting portion, said first position limiting portion is provided on a bottom side of a corresponding one of said notches on said collar, said second position limiting portion is provided on a bottom side of said lid.

8. The one-way bearing as claimed in claim 1, wherein, said collar is provided on its one lateral side with a plurality of recessed portions to respectively receive a plurality of springs; and a bottom side of said lid is provided with a plurality of protruding portions to be respectively received in said recessed portions.
